(19) United States
(12) Patent Application Publication
(10) Pub. No.: US 2024/0118150 A1
(43) Pub. Date: Apr. 11, 2024

(54) METHOD FOR TESTING INTERNAL FORCE INCREMENT OF ARCH BRIDGE SUSPENDER BY INERTIAL MEASUREMENT

(71) Applicant: Guangxi Transportation Science and Technology Group Co., Ltd, Nanning (CN)

(72) Inventors: Hua Wang, Nanning (CN); Longlin Wang, Nanning (CN); Tianzhi Hao, Nanning (CN); Zehua Xie, Nanning (CN); Mengsheng Yu, Nanning (CN); Xiaoli Zhuo, Nanning (CN); Yuhou Yang, Nanning (CN); Jiejun Ning, Nanning (CN); Xirui Wang, Nanning (CN); Xi Peng, Nanning (CN); Kainan Huang, Nanning (CN); Junhong Wu, Nanning (CN)

(21) Appl. No.: 17/763,988

(22) PCT Filed: Oct. 8, 2021
(86) PCT No.: PCT/CN2021/122628

§ 371 Date: Apr. 14, 2022

(30) Foreign Application Priority Data
Oct. 9, 2020 (CN) 202011072894.7

(51) Int. Cl. G01L 5/00

(52) U.S. Cl. CPC G01L 5/0028

(57) ABSTRACT

The present disclosure provides a method for testing an internal force increment of an arch bridge suspender by inertial measurement, including the following steps: (1) selecting a suspender to be tested with internal force increment, and mounting an acceleration sensing device or a speed sensing device at a lower edge of the suspender to be tested; (2) setting an appropriate sampling frequency and collecting signals; (3) processing information data collected in step (2) by using Formulas; and (4) recording a result of the information data processing and obtaining the internal force increment of the suspender. The method can obtain the internal force increment of the suspender by collecting acceleration or speed signals of the lower edge of the suspender and performing calculation from the signals. This method has the advantages of simple and convenient testing, high replicability and low test cost.

### CROSS REFERENCE TO RELATED APPLICATION

This patent application claims the benefit and priority of Chinese Patent Application No. 202011072894.7, entitled “METHOD FOR TESTING INTERNAL FORCE INCREMENT OF ARCH BRIDGE SUSPENDER BY INERTIAL MEASUREMENT” filed with the China National Intellectual Property Administration (CNIPA) on Oct. 9, 2020, the disclosure of which is incorporated by reference herein in its entirety as part of the present application.

### TECHNICAL FIELD

The present disclosure relates to the field of engineering testing technology, and in particular, to a method for testing an internal force increment of an arch bridge suspender by inertial measurement.

### BACKGROUND ART

A suspender is a critical force transferring member for an arch bridge, and its safety is directly related to normal operation of the suspender and the arch bridge. Nevertheless, due to serving in harsh environment and especially affected by random fluctuating loads such as vehicles and wind, a suspender is prone to damage. Accordingly, it is necessary and urgent to monitor the internal force of a suspender in real time.

Existing testing methods for the internal force of a suspender mainly include a frequency method, a magnetic flux method, and a pressure ring method. Among them, because of large test errors, the frequency method and the magnetic flux method cannot measure the internal force increment of a suspender resulting from vehicle and wind loads. The pressure ring method is high in identification accuracy and can test the internal force increment accurately. However, a pressure ring needs to be mounted during the construction of a bridge. Moreover, a pressure ring sensor is expensive. As a result, such as method is not suitable for existing bridges. In view of the above-mentioned problems, there is an urgent need to provide a method for measuring an internal force increment of a bridge suspender that features simple and convenient testing, high test accuracy and low test cost.

### SUMMARY

On this basis, it is necessary to provide a method for testing an internal force increment of an arch bridge suspender by inertial measurement to facilitate measurement of the internal force increment of an existing bridge suspender with the advantages of simple and convenient testing and high accuracy.

To implement the above objectives, the present disclosure provides the following solutions.

A method for testing an internal force increment of an arch bridge suspender by inertial measurement includes the following steps:
(1) selecting a suspender to be tested with internal force increment, and mounting an acceleration sensing device or a speed sensing device at a lower edge of the suspender to be tested;
(2) setting an appropriate sampling frequency and collecting signals;
(3) processing information data collected in step (2) by using the following Formulas:
where when collected by using the acceleration sensing device, the data is processed by using the following Formula:

$$Δ F = \frac{E A {\int }_{0}^{t} {\int }_{0}^{t} a d t d t}{L} ,$$

where ΔF is the internal force increment of the suspender, while L a length of the suspender, E an elasticity modulus of the suspender, A a cross sectional area of the suspender, a an acceleration of the lower edge of the suspender, and t time;
when collected by using the speed sensing device, the data is processed by using the following Formula:

$$Δ F = \frac{E A {\int }_{0}^{t} v d t}{L} ,$$

where v is a speed of the lower edge of the suspender at any time; and
(4) recording a result of the information data processing and obtaining the internal force increment of the suspender.

Compared with the prior art, the present disclosure has the following beneficial effects.
(1) The present disclosure provides a method for testing an internal force increment of an arch bridge suspender by inertial measurement that can obtain the internal force increment of the suspender by collecting acceleration or speed signals of the lower edge of the suspender and performing calculation from the collected signals. This method has the advantages of simple and convenient testing, high replicability and low test cost as well as extensive applicability and high test result accuracy.
(2) The present disclosure combines a method for testing an internal force increment of an arch bridge suspender by inertial measurement with a traditional testing method, whereby the internal force values of a suspender at different times, i.e., a random load spectrum of the suspender, can be obtained easily. The random load spectrum enables further study on the suspender. Thus, this method has promising application prospects.

### DETAILED DESCRIPTION OF THE EMBODIMENTS

The following embodiment may help a person skilled in the art to comprehensively understand the present disclosure but cannot be construed as limiting the present disclosure in any way.

A method for testing an internal force increment of an arch bridge suspender by inertial measurement includes the following steps:
(1) A suspender to be tested with internal force increment is selected, and an acceleration sensing device or a speed sensing device is mounted at a lower edge of the suspender to be tested.
(2) An appropriate sampling frequency is set, and signals are collected.
(3) Information data collected in step (2) is processed by using the following Formulas:

When collected by using the acceleration sensing device, the data is processed by using the following Formula:

$$Δ F = \frac{E A {\int }_{0}^{t} {\int }_{0}^{t} a d t d t}{L} ,$$

where ΔF is the internal force increment of the suspender, while L a length of the suspender, E an elasticity modulus of the suspender, A a cross sectional area of the suspender, a an acceleration of the lower edge of the suspender, and t time.

When collected by using the speed sensing device, the data is processed by using the following Formula:

$$Δ F = \frac{E A {\int }_{0}^{t} v d t}{L} ,$$

where v is a speed of the lower edge of the suspender at any time.
(4) A result of the information data processing is recorded, thereby obtaining the internal force increment of the suspender.

For example, when the acceleration sensing device is used, the technical solution of the method provided in the present disclosure is as follows: the acceleration sensing device is fixed at the lower end of the arch bridge suspender to collect an acceleration of the end of the suspender in real time. The acceleration of the end of the suspender collected by the acceleration sensing device is then converted into a displacement of the end of the suspender by using an integral formula based on an integral relation between acceleration and displacement. Subsequently, the displacement of the end of the suspender is converted into an internal force of the suspender by using a mechanical formula based on a mechanical relation among displacement, deformation and internal force. As a result, the internal force increment of the suspender can be obtained.

The Formulas involved in step (3) are derived as follows:

When the surface of a bridge bears a dynamic load, the suspender may be deformed continuously under the action of the load. An arch rib may have great rigidity, and therefore, its deformation is tiny and substantially can be ignored. Thus, the deformation of the suspender is mainly concentrated at the lower edge. Accordingly, the acceleration sensing device can be arranged at the lower edge of the suspender to collect the acceleration a of the lower edge of the suspender in real time. Let the displacement of the lower edge of the suspender be ΔL, the following relation may be established:

ΔL=∫₀^{t}∫₀^{t}adtdt (1)
where t is time.

In case of axial deformation of the suspender, the strain ε along the axis and the stress σ on the cross section are as follows:

$$ε = \frac{Δ L}{L} \qquad ( 2 )$$

$$σ = \frac{Δ F}{A} \qquad ( 3 )$$

$$σ = E ε \qquad ( 4 )$$

where L is the length of the suspender, while ΔF the internal force increment of the suspender, A the cross sectional area of the suspender, and E the elasticity modulus of the suspender.

The Formula (2) and the Formula (3) can be substituted into the Formula (4) to obtain the relation between ΔL and ΔF:

$$Δ L = \frac{Δ FL}{EA} \qquad ( 5 )$$

The Formula (5) can be substituted into the Formula (1) to obtain the internal force increment ΔF of the suspender at any time:

$$Δ F = \frac{E A {\int }_{0}^{t} {\int }_{0}^{t} a d t d t}{L} \qquad ( 6 )$$

That is, the Formula (6) is the formula used to process data in step (2) when the data is collected by using the acceleration sensing device.

In addition, similarly, when the speed sensing device is arranged at the lower edge of the suspender, the speed sensing device is used to test the speed v of the lower edge of the suspender at any time. Similar to the above derivation process, the following Formula (7) used to process data collected by the speed sensing device in step (2) is obtained:

$$Δ F = \frac{E A {\int }_{0}^{t} v d t}{L} . \qquad ( 7 )$$

From the foregoing, the method provided in the present disclosure can obtain the internal force increment of an arch bridge suspender accurately. Furthermore, the method is simple and convenient in testing, high in test accuracy, low in test cost, convenient to operate, and high in feasibility.

While the present disclosure has been described in detail above with reference to general description and a specific embodiment, it will be apparent to those skilled in the art that some modifications or improvements can be made to the present disclosure. Therefore, all these modifications or improvements made without departing from the spirit of the present disclosure fall within the protection scope of the present disclosure.

What is claimed is:

1. A method for testing an internal force increment of an arch bridge suspender by inertial measurement, comprising:
(1) selecting a suspender to be tested with internal force increment, and mounting an acceleration sensing device or a speed sensing device at a lower edge of the suspender to be tested;
(2) setting an appropriate sampling frequency and collecting signals;
(3) processing information data collected in step (2) by using the following Formulas:
wherein when collected by using the acceleration sensing device, the data is processed by using the following Formula:
$$Δ F = \frac{E A {\int }_{0}^{t} {\int }_{0}^{t} a d t d t}{L} ,$$
wherein ΔF is the internal force increment of the suspender, while L a length of the suspender, E an elasticity modulus of the suspender, A a cross sectional area of the suspender, a an acceleration of the lower edge of the suspender, and t time;
when collected by using the speed sensing device, the data is processed by using the following Formula:
$$Δ F = \frac{E A {\int }_{0}^{t} v d t}{L} ,$$
wherein v is a speed of the lower edge of the suspender at any time; and
(4) recording a result of the information data processing and obtaining the internal force increment of the suspender.
